(19) United States
(12) Patent Application Publication
(10) Pub. No.: US 2023/0410041 A1
(43) Pub. Date: Dec. 21, 2023

(54) METHODS FOR DETECTING VARIABLE WEIGHT-PRICE ITEMS IN DETECTOR-BASED INVENTORY MANAGEMENT AND/OR SHOPPING SYSTEMS

(71) Applicant: Avery Dennison Retail Information Services LLC, Mentor, OH (US)

(72) Inventors: Mark ROTH, North Miami, FL (US); Curtis T. STACKABLE, Clawson, MI (US); Pedro GARZA, Austin, TX (US); Frederick BLECKMANN, Barrington, NH (US)

(21) Appl. No.: 18/249,992

(22) PCT Filed: Oct. 22, 2021
(86) PCT No.: PCT/US2021/056182

§ 371 Date: Apr. 21, 2023

Related U.S. Application Data
(60) Provisional application No. 63/104,645, filed on Oct. 23, 2020.

(51) Int. Cl. G06Q 10/087; G06Q 20/20; G07G 1/00

(52) U.S. Cl. CPC G06Q 10/087; G06Q 20/203; G06Q 20/208; G07G 1/009

(57) ABSTRACT

Methods and systems for detecting activity of variable weight-price items in detector-based inventory management and shopping systems in merchandising and/or storage areas are described herein. The methods described herein involve the use of multi-detector systems containing one or more digital triggers which can be read/detected in order to obtain a unique digital identity for the items. In some embodiments, the digital trigger is an RFID inlay and the detector-based system is a vision- or camera-based walk out shopping systems in order to detect variable weight-price items. In some embodiments, the vision- or camera-based walk out shopping system is deployed in a grocery store and the variable-weight items are selected from meats, cheeses, seafood, fruits and vegetables, deli items, salad bars, bulk items (e.g., nuts, coffee beans, grains, etc.) and combinations thereof. In some embodiments, the sensors provide item level unique individual identification of the variable weight-price items to enhance the data fusion used to monitor these products by current employed ecosystems.

### CROSS-REFERENCE TO RELATED APPLICATION(S)

The present application claims the benefit of U.S. Provisional Patent Application No. 63/104,645 filed Oct. 23, 2020, which is incorporated herein by reference in its entirety.

### FIELD

The present disclosure is in the field of methods of detecting variable weight-price items in detector-based inventory management and/or shopping systems.

### BACKGROUND

Cashier-less retail dates back to the late 1800's. These systems have evolved from vending equipment to full retail stores where shoppers are tracked by vision-based systems and monitored via artificial intelligence and machine learning.

Vision-based systems are proficient at identifying what type of product is in the system's view and following shoppers through a space. However, these systems have limitations when identifying particular or unique items, especially when the items are closely placed or stacked one over the other in localized areas, such as merchandising and/or storage areas.

Many retail items are unique such that they elude camera- or other vision-based systems. Examples of such items include, but are not limited to, perishables, variable weight-price products such as proteins (e.g., meats, seafood, etc.), fruits, vegetables, bakery products, premade meals, deli products, beverages, dairy products, and general inventory circulation as well as non-food items which are variable weight-price items.

There is a need for methods and systems for detecting the local activity of one or more variable weight-price or perishable items in detector-based systems.

There is a need for shopping detection methods and systems to be able to identify or detect particular products not only for inventory management and asset tracking but also to identify which product(s) was selected or removed from a shelf, cooler, table, display rack, or other retail container or fixture.

Methods and systems for detecting items that cannot be detected by sensor-based systems, such as camera- or other vision-based systems alone are described herein. In addition, the methods and systems described herein also provide data that complements the activity that sensor-based systems are deployed to monitor, enhancing the data and providing depth to the data that was previously not available.

### SUMMARY

Methods for detecting variable weight-price items in detector-based inventory management and/or shopping systems are described herein. In some embodiments, the detector-based inventory shopping system is a camera- or vision-based cashier-less or checkout-free shopping system.

In some embodiments, item level sensors, such as RFID tags, are incorporated into detector-based inventory management and/or shopping systems in order to detect variable weight-price items or perishable items. In some embodiments, the detector-based system is a camera- or vision-based cashier-less or checkout-free shopping system deployed in a grocery store and the variable-weight items are selected from meats, cheeses, seafood, fruits and vegetables, deli items, salad bars, bulk items (e.g., nuts, coffee beans, grains, etc.) and combinations thereof. These items may be assembled by grocery store staff or customers. In some embodiments, containers may be filled by consumer choice, weighed and the weight encoded or written into the item level sensor by the weighing device. In other embodiments, the weight may be recorded or stored on a local device or in the cloud and is accessed when the customer checks out. In some embodiments, the addition of RFID technologies provides item level unique individual identification of the variable weight-price items to enhance the data fusion used to monitor these products by currently employed ecosystems.

In addition to food products, the methods described herein can be used in relation to a variety of types of consumer goods including, but not limited to, clothing, footwear, and accessories, wine and spirits, consumer electronics, vehicles (cars, trucks, personal watercraft); sporting goods, personal care products, etc.

### BRIEF DESCRIPTION OF THE DRAWINGS

FIG. 1 is a schematic of an RFID inlay suitable for use with plastic packaging. FIG. 1a is a photograph of a plastic container containing strawberries having a label containing the inlay of FIG. 1.

FIG. 2 is a schematic of a low profile RFID inlay suitable for use with difficult to read materials. FIG. 2a is a photograph of a block of cheese having affixed thereto a label containing the inlay of FIG. 2.

FIG. 3 is a schematic of a low profile RFID inlay suitable for use with difficult to read materials.

FIG. 4 is a schematic of a microwave-safe RFID inlay. FIG. 4a is a photograph of packaging for steak containing a foam try and plastic wrap to which a label containing the inlay of FIG. 4 can be affixed.

FIG. 5 is a representation of phased array antenna grid which provides a controllable read zone segment by cycling through signals that are transverse in phase.

FIG. 6 is a representation of a plurality of smart shelves connected to a central control unit via USB cables.

FIG. 7 is a representation of a plurality of smart shelves that define read area #1.

FIG. 8 is a representation of read area #2.

FIG. 9 is a representation of how RFID-tagged products, A, B, and C, are arranged on smart shelves that define read area #1.

FIG. 10 is a representation of how RFID-tagged products, A, B, and C, are arranged on smart shelves and are detected by read area #2.

FIG. 11 is a representation of a plurality of smart shelves that define read area #1.

FIG. 12 is a representation of read area #2.

FIG. 13 is a representation of a plurality of antenna making up two sides of a product container/cooler as read area #1 and position of read area #2.

FIG. 14 is a representation of multiple data paths from multiple sources

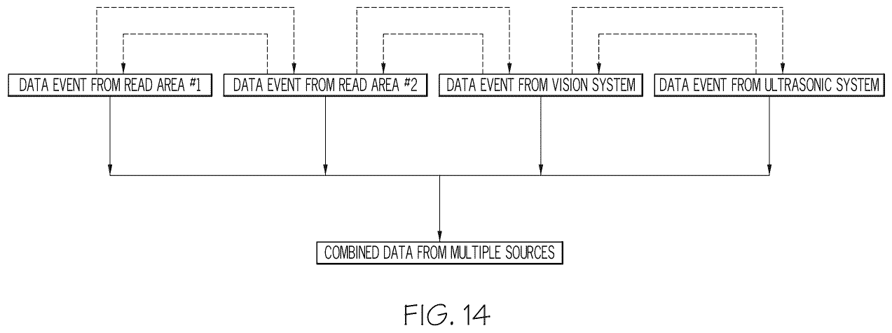

### I. DEFINITIONS

“Detector-based inventory management and/or shopping systems” as used herein typically refers to a systems containing one or more types of detectors that can confirm the presence of a product in an area; detect the movement of a product within an area or between areas in a merchandising and/or storage location; and/or provide a cashier-less or checkout-free shopping experience. Non-limiting examples of detectors include cameras or other vision-based devices; detectors containing a radio frequency sources, such as RFID readers, etc.; and/or detectors containing visible or non-visible light source.

“Vision- or camera-based checkout free or cashier less shopping systems”, as used herein, means systems that use vision- or camera-based hardware and software to detect the movement of objects, for example, from a retail shelf and optionally placing them in a cart or basket and do not require a cashier or checkout location/kiosk for the consumer to check out.

“Digital trigger”, as used herein, means any type of sensor that can be detected/read by a source. The source can use electromagnetic energy, such as radio frequencies, infra-red frequencies, visible and non-visible light frequencies, etc. Examples include, but are not limited to, RFID (e.g., UHF, HF), NFC, QR Codes, bar codes, etc. or cameras and other vision-based devices, and combinations thereof.

“Merchandising area”, as used herein, typically refers to an area in retail location where products are located, arranged, etc. for sale/purchase.

“Storage area”, as used herein, typically refers to an area in a retail location where products are stored, e.g., stock room, warehouse, etc.

“Merchandising area” and “storage area” can be referred together or individually as a “localized area”.

### II. VARIABLE WEIGHT-PRICE SOLUTIONS

Methods for detecting variable weight-price items in detector-based, e.g., vision- or camera-based walk out shopping systems, are described herein. In some embodiments, the variable weight-price items are food items, such as cheeses, deli meats, proteins, produce, food items sold in bulk, etc. In some embodiments, the variable weight items are non-food items, such as items sold in bulk. In some embodiments, non-food items that are currently sold packaged with a finite number of items within the package can be sold loose as bulk items.

In some embodiments, systems and methods for detecting the activity of one or more variable weight-price or perishable items using a multi-detector system is described herein. In some embodiments, the systems and methods include or involve affixing to the variable weight-price or perishable items one or more tags containing one or more digital identities and one or more digital triggers and detecting the tagged variable weight-price item, via the digital triggers, in a merchandising and/or storage area. In some embodiments, the digital trigger is, or is part of, a tag or label which is affixed or adhered to the product. In some embodiments, the digital trigger is a trigger that can be detected or read by radio frequencies including, but not limited, RFID (HF, UHF) and NFC. Other digital triggers include, but are not limited to, QR codes and bar codes. In other embodiments, the inlay tagged to the items for detection of activity of the items is a Bluetooth Low Energy (BLE) tag.

In some embodiments, a unique digital identity associated with the product is encoded into the digital trigger. Exemplary digital identities include, but are not limited to, an electronic product code, a serial number, an expiration date, a sell by date, a package date, or combination thereof. In some embodiments, the digital identities employed and encoded in, or on, the digital trigger may be configured as a machine readable code and may be associated with metadata. In some embodiments, the one or more digital identities may be associated with an image captured by a vision or camera based systems. In some embodiments, the digital trigger is an RFID inlay having a digital identity encoded therein. In other embodiments, the digital trigger is a trigger other than an RFID inlay or is a trigger in combination with an RFID inlay.

In some embodiments, the one or more detectors in the multi-detector system include a camera or other vision-based devices. In some embodiments, RFID technologies are incorporated into vision- or camera-based walk out shopping systems in order to detect variable weight-price items. In some embodiments, the vision- or camera-based walk out shopping system is deployed in a grocery store and the variable-weight items are selected from meats, cheeses, seafood, fruits and vegetables, deli items, salad bars, bulk items (e.g., nuts, coffee beans, grains, etc.) and combinations thereof. In some embodiments, these items may be assembled by grocery store staff or customers. In some embodiments, containers may be filled by consumer choice, weighed, and recorded by a container carrying data within the container. In some embodiments, the camera or vision-based detector can be a hand held device, such as a mobile device (smart phone, tablet, smart watch, etc.). In other embodiments, the camera or vision-based device is permanently mounted in the retail location, for example, overhead or in, or adjacent to, the merchandising location.

In some embodiments, the addition of RFID technologies provides item level unique individual identification of the variable weight-price items to enhance the data fusion used to monitor these products by current employed ecosystems.

The methods and systems described herein enable the detection of an activity of the tagged variable weight-priced items or perishable items in a merchandising and/or storage area. In some embodiments, the activity involves inventory management or merchandising of the one or more weight-price or perishable items. In other embodiments, the activity could involve adding or removing one or more items from the localized area.

A. Sensors/Inlays

The sensor can be any sensor known in the art that is suitable for the methods and applications described herein. In some embodiments, the sensor is, for example, an item level sensor, such as a radio frequency identification (RFID, such as UHF or HF) sensor, a near field communication (NFC) sensor, a quick response (QR) code, machine readable code, vision system, Bluetooth Low Energy (BLE) beacons, or other digital identification (ID) system, or combinations thereof. In some embodiments, the item level sensor is UHF Gen2 RFID or similar standard. Other standards established by various standards setting bodies can also be used. Such standards may be item/product specific or sector or market specific.

1. RFID

Radio Frequency item level sensors, also referred to as RFID tags, are wireless devices with various amounts of memory, typically an EPC memory space of 96-128 bits, a TID memory space of 48-96 bits, and optional features such as user memories described in GS1. These sensors have a unique ID, respond to RF energy and broadcast the presence of particular items to which they are attached. There are several factors that influence the range and readability of RFID item level sensor and antenna (inlay) including size, power and frequency. Materials with high water content or metal packaging can influence the power response and or de-tune the frequency response. Packaging size, human readable data requirements and merchandising also need to be considered in a deployment and sensor choice.

A variety of RFID item level sensor designs optimizing performance for standard and less common materials are available. To evaluate the most effective inlay, RFID item level sensors cab be tested on cheeses, packaged fruit, and meat products to determine the appropriate sensor. In some embodiments, a variety of different sensors are used depending on the item to be tagged and/or the packing used with the item.

A typical RFID device generally includes an antenna for wirelessly transmitting and/or receiving RF signals and analog and/or digital electronics operatively connected thereto. So called active or semi-passive RFID devices may also include a battery or other suitable power source. Commonly, the electronics are implemented via an integrated circuit (IC) or microchip or other suitable electronic circuit and may include, e.g., communications electronics, data memory, control logic, etc. In operation, the IC or microchip functions to store and/or process information, modulate and/or demodulate RF signals, as well as optionally performing other specialized functions. In general, RFID devices can typical retain and communicate enough information to uniquely identify individuals, packages, inventory and/or other like objects, e.g., to which the RFID device is affixed.

Commonly, an RFID reader or base station is used to wirelessly obtain data or information (e.g., such as an identification code) communicated from an RFID device. Typically, an RFID device is configured to store, emit, or otherwise exhibit an identification code or other identifier(s). The manner in which the RFID reader interacts and/or communicates with the RFID device generally depends on the type of RFID device. A given RFID device is typically categorized as a passive device, an active device, a semi-passive device (also known as a battery-assisted or semi-active device) or a beacon type RFID device (which is generally considered as a sub-category of active devices). Passive RFID devices generally use no internal power source, and as such, they are passive devices which are only active when an RFID reader is nearby to power the RFID device, e.g., via wireless illumination of the RFID device with an RF signal and/or electromagnetic energy from the RFID reader. Conversely, semi-passive and active RFID devices are provided with their own power source (e.g., such as a small battery). To communicate, conventional RFID devices (other than so called beacon types) respond to queries or interrogations received from RFID readers. The response is typically achieved by backscattering, load modulation and/or other like techniques that are used to manipulate the RFID reader's field. Commonly, backscatter is used in far-field applications (i.e., where the distance between the RFID device and reader is greater than approximately a few wavelengths), and alternately, load modulation is used in near-field applications (i.e., where the distance between the RFID device and reader is within approximately a few wavelengths).

Passive RFID devices typically signal or communicate their respective data or information by backscattering a carrier wave from an RFID reader. That is, in the case of conventional passive RFID devices, in order to retrieve information therefrom, the RFID reader typically sends an excitation signal to the RFID device. The excitation signal energizes the RFID device which transmits the information stored therein back to the RFID reader. In turn, the RFID reader receives and decodes the information from the RFID device.

As previously noted, passive RFID devices commonly have no internal power supply. Rather, power for operation of a passive RFID device is provided by the energy in the incoming RF signal received by the RFID device from the RFID reader. Generally, a small electrical current induced in the antenna of the RFID device by the incoming RF signal provides sufficient power for the IC or microchip in the RFID device to power up and transmit a response. This means that the antenna generally has to be designed both to collect power from the incoming signal and also to transmit the outbound backscatter signal.

Passive RFID devices have the advantage of simplicity and long life (e.g., having no battery to go dead). Nevertheless, their performance may be limited. For example, passive RFID devices generally have a more limited range as compared to active RFID devices.

Active RFID devices, as opposed to passive ones, are generally provisioned with their own transmitter and a power source (e.g., a battery, photovoltaic cell, etc.). In essence, an active RFID device employs the self-powered transmitter to broadcast a signal which communicates the information stored on the IC or microchip in the RFID device. Commonly, an active RFID device will also use the power source to power the IC or microchip employed therein.

Generally, there are two kinds of active RFID devices-one can be considered as a transponder type of active RFID device and the other as a beacon type of active RFID device. A significant difference is that active transponder type RFID devices are only woken up when they receive a signal from an RFID reader. The transponder type RFID device, in response to the inquiry signal from the RFID reader, then broadcasts its information to the reader. As can be appreciated, this type of active RFID device conserves battery life by having the device broadcast its signal only when it is within range of a reader. Conversely, beacon type RFID devices transmit their identification code and/or other data or information autonomously (e.g., at defined intervals or periodically or otherwise) and do not respond to a specific interrogation from a reader.

Generally, active RFID devices, due to their on-board power supply, may transmit at higher power levels (e.g., as compared to passive devices), allowing them to be more robust in various operating environments. However, the battery or other on-board power supply can tend to cause active RFID devices to be relatively larger and/or more expensive to manufacture (e.g., as compared to passive devices). Additionally, as compared to passive RFID devices, active RFID devices have a potentially more limited shelf life—i.e., due to the limited lifespan of the battery. Nevertheless, the self-supported power supply commonly permits active RFID devices to include generally larger memories as compared to passive devices, and in some instances the on-board power source also allows the active device to include additional functionality, e.g., such as obtaining and/or storing environmental data from a suitable sensor.

Semi-passive RFID devices are similar to active devices in that they are typically provisioned with their own power source, but the battery commonly only powers the IC or microchip and does not provide power for signal broadcasting. Rather, like passive RFID devices, the response from the semi-passive RFID device is usually powered by means of backscattering the RF energy received from the RFID reader, i.e., the energy is reflected back to the reader as with passive devices. In a semi-passive RFID device, the battery also commonly serves as a power source for data storage.

A conventional RFID device will often operate in one of a variety of frequency ranges including, e.g., a low frequency (LF) range (i.e., from approximately 30 kHz to approximately 300 kHz), a high frequency (HF) range (i.e., from approximately 3 MHz to approximately 30 MHz) and an ultra-high frequency (UHF) range (i.e., from approximately 300 MHz to approximately 3 GHz). A passive device will commonly operate in any one of the aforementioned frequency ranges. In particular, for passive devices: LF systems commonly operate at around 124 kHz, 125 kHz or 135 kHz; HF systems commonly operate at around 13.56 MHz; and, UHF systems commonly use a band anywhere from 860 MHz to 960 MHz. Alternately, some passive device systems also use 2.45 GHz and other areas of the radio spectrum. Active RFID devices typically operate at around 455 MHz, 2.45 GHz, or 5.8 GHz. Often, semi-passive devices use a frequency around 2.4 GHz.

The read range of an RFID device (i.e., the range at which the RFID reader can communicate with the RFID device) is generally determined by many factors, e.g., the type of device (i.e., active, passive, etc.). In some embodiments, passive LF RFID devices (also referred to as LFID or LowFID devices) can usually be read from within approximately 12 inches (0.33 meters); passive HF RFID devices (also referred to as HFID or HighFID devices) can usually be read from up to approximately 3 feet (1 meter); and passive UHF RFID devices (also referred to as UHFID devices) can be typically read from approximately 10 feet (3.05 meters) or more. However, the distances above are exemplary and the distances may vary (e.g., longer or shorter) depending on the characteristics listed above. One important factor influencing the read range for passive RFID devices is the method used to transmit data from the device to the reader, i.e., the coupling mode between the device and the reader-which can typically be either inductive coupling or radiative/propagation coupling. Passive LFID devices and passive HFID devices commonly use inductive coupling between the device and the reader, whereas passive UHFID devices commonly use radiative or propagation coupling between the device and the reader.

In inductive coupling applications (e.g., as are conventionally used by passive LFID and HFID devices), the device and reader are typically each provisioned with a coil antenna that together form an electromagnetic field there between. In inductive coupling applications, the device draws power from the field, uses the power to run the circuitry on the device's IC or microchip and then changes the electric load on the device antenna. Consequently, the reader antenna senses the change or changes in the electromagnetic field and converts these changes into data that is understood by the reader or adjunct computer. Because the coil in the device antenna and the coil in the reader antenna have to form an electromagnetic field there between in order to complete the inductive coupling between the device and the reader, the device often has to be fairly close to the reader antenna, which therefore tends to limit the read range of these systems.

Alternately, in radiative or propagation coupling applications (e.g., as are conventionally used by passive UHFID devices), rather than forming an electromagnetic field between the respective antennas of the reader and device, the reader emits electromagnetic energy which illuminates the device. In turn, the device gathers the energy from the reader via its antenna, and the device's IC or microchip uses the gathered energy to change the load on the device antenna and reflect back an altered signal, i.e., backscatter. Commonly, UHFID devices can communicate data in a variety of different ways, e.g., they can increase the amplitude of the reflected wave sent back to the reader (i.e., amplitude shift keying), shift the reflected wave so it is out of phase received wave (i.e., phase shift keying) or change the frequency of the reflected wave (i.e., frequency shift keying). In any event, the reader picks up the backscattered signal and converts the altered wave into data that is understood by the reader or adjunct computer.

The antenna employed in an RFID device is also commonly affected by numerous factor, e.g., the intended application, the type of device (i.e., active, passive, semi-active, etc.), the desired read range, the device-to-reader coupling mode, the frequency of operation of the device, etc. For example, insomuch as passive LFID devices are normally inductively coupled with the reader, and because the voltage induced in the device antenna is proportional to the operating frequency of the device, passive LFID devices are typically provisioned with a coil antenna having many turns in order to produce enough voltage to operate the device's IC or microchip. Comparatively, a conventional HFID passive device will often be provisioned with an antenna which is a planar spiral (e.g., with 5 to 7 turns over a credit-card-sized form factor), which can usually provide read ranges on the order of tens of centimeters. Commonly, HFID antenna coils can be less costly to produce (e.g., compared to LFID antenna coils), since they can be made using techniques relatively less expensive than wire winding, e.g., lithography or the like. UHFID passive devices are usually radiatively and/or propagationally coupled with the reader antenna and consequently can often employ conventional dipole-like antennas.

a. Sensors for Plastic Packaging

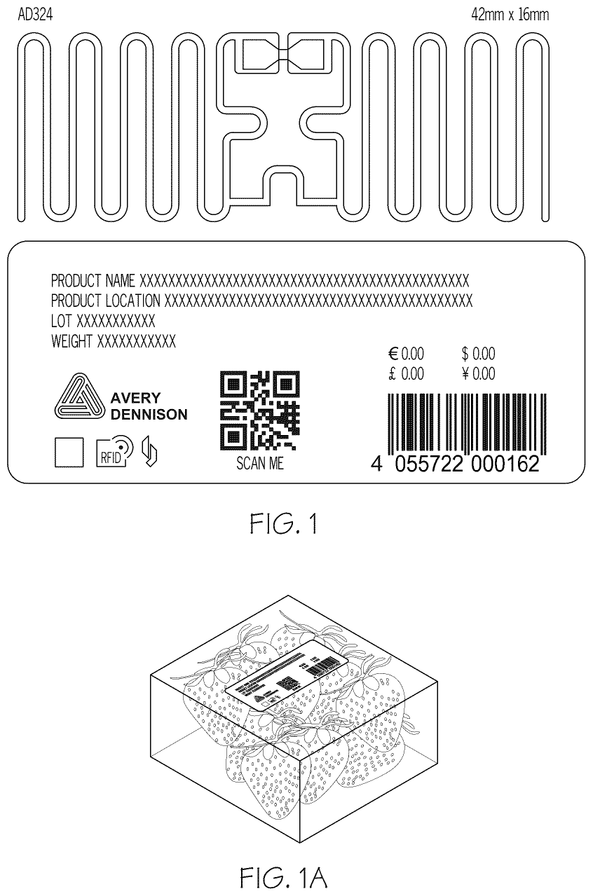

In some embodiments, the one or more sensors are designed for plastic packaging. In some embodiments, the plastic packaging is used to package fresh cut fruits and/or vegetable. Suitable sensors are available from Avery Dennison. In some embodiments, the sensor is model AD324 as shown in FIGS. 1 and 1a. In some embodiments, the RFID sensor placement on the packaging is such that the product inside the package does not overlap the inlay area by more than 20% when the product is at rest on a shelf. In some embodiments, the RFID sensor may be a low profile inlay to reduce coverage area.

b. Low Profile Sensors

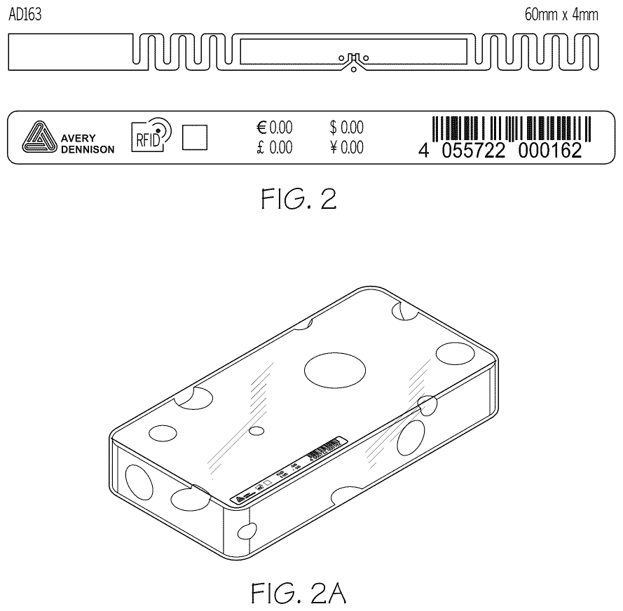

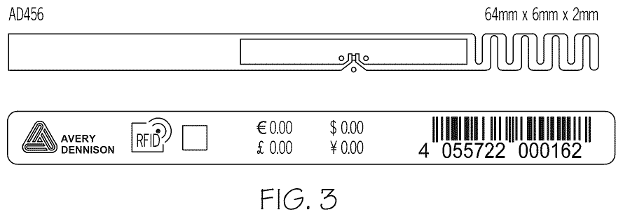

In some embodiments, the one or more sensors are low profile item level sensors for difficult to read materials. In some embodiments, these sensors are used on packaged cheeses. In some embodiments, the sensors are AD163 and AD456 (FIGS. 2, 2a, and 3) available from Avery Dennison. In some embodiments, the sensors can be mounted flush, with a spacer or lifted along its length to form a low profile flag tag. In some embodiments, the tag contains a built-in structure that separates the dielectric qualities of the product and the inlay. In some embodiments, the low profile inlay size is used to reduce coverage area.

c. Microwave-Safe Inlays

In some embodiments, the RFID sensor is a microwave-safe sensor. Microwave-safe sensors/inlays are described in WO2018/125977, WO2019/204694, WO/2019/204698, WO/2019/204704, WO2020/006202, and WO2020/006219 and U.S. Ser. No. 62/954,909 and 62/954,454, which are incorporated herein by reference.

In some embodiments, the microwave safe RFID tag includes an antenna defining a gap and configured to operate at a first frequency. An RFID chip and an antenna electrically coupled to the antenna across the gap. A shielding structure is electrically coupled to the antenna across the gap and overlays the RFID chip. The shielding structure includes a shield conductor and a shield dielectric at least partially positioned between the shield conductor and the RFID chip. The shielding structure is configured to limit the voltage across the gap when the antenna is exposed to a second frequency that is greater than the first frequency.

In some embodiments, the antenna is, or contains, an antenna with a sheet resistance in the range of approximately 100 ohms to approximately 230 ohms. In another aspect, an RFID tag includes an RFID chip and an antenna electrically coupled to the RFID chip. The antenna is, or contains, a conductor formed of a base material and a second material with different coefficients of thermal expansion configured to cause the antenna to fracture into multiple pieces upon being subjected to heating.

In some embodiments, the microwave-safe RFID tag includes a substrate having opposing first and second surfaces. An antenna is secured to the first surface, defines a gap, and is configured to operate at a first frequency. An RFID chip is electrically coupled to the antenna across the gap. A shielding structure is secured to the second surface of the substrate, with at least a portion of the shielding structure being in substantial alignment with the gap. The shielding structure is configured to limit the voltage across the gap when the antenna is exposed to a second frequency that is greater than the first frequency.

In some embodiments, the antenna of the RFID tag is no larger than 40 mm in the maximum dimension. In some embodiments, a center of the shielding structure is substantially aligned with the RFID chip. In some embodiments, the shielding structure is larger than the gap. In some embodiments, the shielding structure is electrically coupled to the antenna through the substrate. In some embodiments, the RFID tag further includes first and second conductive bridges that extend between the antenna and the shielding structure through the substrate so that the first and second conductive bridges are associated with the antenna at opposing sides of the gap. In some embodiments, the first and second conductive bridges are substantially identical. In some embodiments, the first and second conductive bridges are substantially equally spaced from the gap. In some embodiments, each of the first and second conductive bridges is positioned closer to an associated edge of the shielding structure than to the gap. In some embodiments, each of the first and second conductive bridges comprises an electro-chemically formed via. In some embodiments, each of the first and second conductive bridges comprise a crimp. In some embodiments, each of the first and second conductive bridges comprise conductive ink(s) received by a respective hole defined in the substrate.

In some embodiments, the microwave tolerant RFID tag device can be secured to an item to be placed in a microwave field, such as food item, to be thawed, heated, reheated or cooked in a microwave oven. The RFID tag device contains at least one antenna designed to operate at one or more frequencies, and an RFID chip carrying data related to the product to which it is attached and/or the microwave process (e.g., cooking) that the microwave oven is required to perform. In some embodiments, the antenna of the RFID tag device is designed to prevent a destructive arc when placed in a high-level 2.45 GHz field, and minimizes heating of the RFID tag itself during the microwave process.

In other embodiments, an RFID reader system is coupled into a microwave oven cavity to be able to read the RFID tag data before the high-level 2.45 GHz field is applied, as the high-field is likely to destroy the RFID tag device. The RFID reader system may operate at 2.45 GHz and share or be co-located with the oven emitter, or operate at a separate frequency such as UHF in the range of 900 MHz to 930 MHz, or can operate at both frequencies. The RFID reader system then interfaces with the oven controller to authorize and/or control the cooking process of the tagged food item.

In some embodiments, the microwave safe RFID tag preferably contains a split ring (or shield) conductor formed on one side of a dielectric, a coil antenna conductor formed on an opposite side of the dielectric, and a RFID chip. The split ring conductor is separated from the coil antenna conductor by a dielectric. Further, the split ring conductor covers the majority of the coil antenna conductor, such that the split ring conductor capacitively couples to the coil antenna conductor via the dielectric. Additionally, the split ring conductor contains a gap which allows the microwave current to flow through the coil antenna conductor, yet no part of the coil antenna conductor in the gap interacts with the microwave current, which prevents arcing.

In other embodiments, the microwave safe RFID tag device contains a second split ring conductor which is rotated opposite of the first split ring conductor such that the gaps of the conductors do not align and current does not flow in the gaps. The coil antenna conductor is then positioned between the first and the second split ring conductors and capacitively couples to the conductors, effectively shorting the coil antenna conductor and the first and the second split ring conductors to prevent arcing and excessive current flow along the coil antenna conductor.

In other embodiments, the microwave-safe RFID inlay contains a pair of dipole arms extending from a tuning loop, wherein each of said dipole arms terminates in a load end. The conductive structure is further configured to have a metal mass that is less than a standard detection threshold of a metal detector that is used to scan food product items and their packaging. Additionally, the conductive structure has an area large enough to achieve a required or desired performance, but still below the typical standard detection threshold associated with scanning a food item or packaging for a foreign metal object of approximately a 1 mm diameter metal sphere. The conductive structure may be manufactured by printing a conductive ink, or by cutting a metal foil. A thickness of the overall conductive structure is then reduced to no less than a skin depth calculated for the respective conductive structure material and frequency. Portions of each load end may be hollowed out so that areas of the conductive structure having a lower current flow are removed with minimal impact on overall RFID performance, while also achieving a conductive structure with a mass below the detection threshold of the metal detector.

In other embodiments, packaging for a microwavable food item is provided. The packaging includes a first package member configured to be microwaved and a second package member associated with the first member, with the second package member being configured to be dissociated from the first package member prior to microwaving the first package member. The packaging also includes an RFID tag containing a reactive strap and a far-field antenna. The reactive strap is associated with the first package member, while the far-field antenna is associated with the second package member and is separate from the reactive strap. The reactive strap is configured to be coupled to the far-field antenna when the second package member is associated with the first package member and to be decoupled from the far-field antenna when the second package member is dissociated from the first package member. The RFID tag is capable of far-field communication when the reactive strap is coupled to the far-field antenna, while the reactive strap is capable of only near-field communication when it is decoupled from the far-field antenna.

In some embodiments, the microwave-safe RFID sensor is Wavesafe™, available from Avery Dennison. Wavesafe™ is a microwave-safe UHF RFID solution developed by Avery Dennison in 2017 and introduced to the market in 2019, for item-level tagging of fresh and frozen perishable packaged food products ensuring safety compliance. Wavesafe™ is designed to prevent arcing or heat build-up during microwaving while still delivering highly accurate read rates for time tracking.

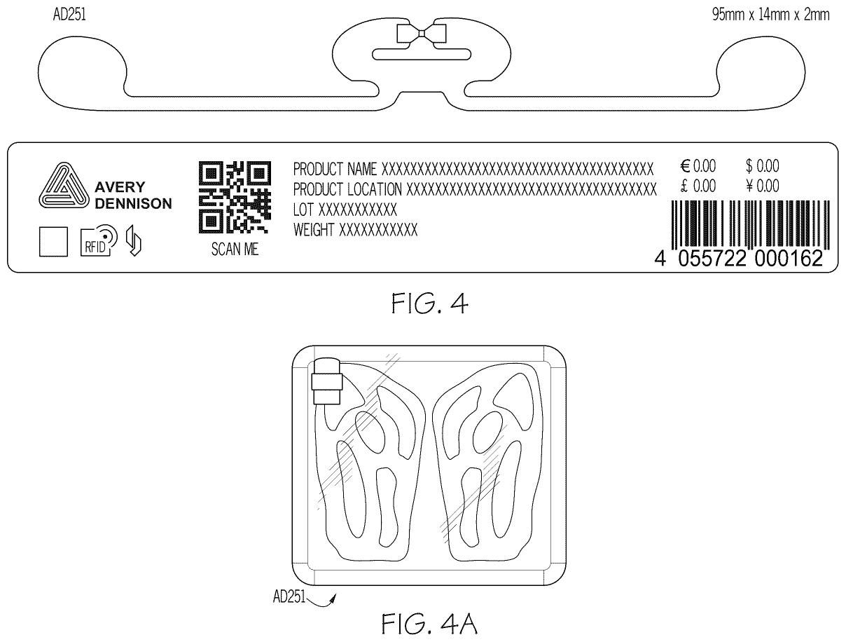

Commercially available sensors include AD251, available from Avery Dennison (FIGS. 4 and 4a). In some embodiments, the microwave-safe inlay is used for meats and seafood, including those packaged in/with foam trays. In some embodiments, the microwave-safe inlay is compliant with TÜV Rheinland® T-Mark certification standards. In some embodiments, the RFID sensor is placed on the outer side of the foam tray to ensure separation from the item.

Packaging including one or more of the sensors described above are also described herein. In some embodiments, the packaging is suitable for packaging variable weight-price items, such as meats, seafood, fresh cut fruits and vegetables, and cheeses.

2. NFC

Near field communication, abbreviated NFC, is a form of contactless communication between mobile devices, such as smartphones or tablets, that utilizes electromagnetic radio fields rather than radio transmissions (e.g., Bluetooth, WiFi). NFC is an offshoot of RFID design for use by device and objects that are in close proximity to each other. Three types of NFC technology are currently in use: Type A, Type B, and FeliCa. The technology behind NFC allows a device, known as a reader, interrogator, or active device, to create a radio frequency current that communicates with another NFC compatible device or a small NFC tag holding the information the reader wants. Passive devices, such as the NFC tags, store information and communicate with the reader but do not actively read other devices. Peer-to-peer communication through two active devices is also a possibility with NFC. This allows both devices to send and receive information.

3. QR Codes

Quick Response (QR) codes are a type of matrix barcode (2-D barcode) which is machine-readable. QR codes often contain data for a locator, identifier, or tracker that points to a website or application. A QR code uses four standardized encoding modes (numeric, alphanumeric, byte/binary, and kanji) to store data efficiently; extensions may also be used. A QR code is detected by a 2-dimensional digital image sensor and then digitally analyzed by a programmed processor. The processor locates the three distinctive squares at the corners of the QR code image, using a smaller square (or multiple squares) near the fourth corner to normalize the image for size, orientation, and angle of viewing. The small dots throughout the QR code are then converted to binary numbers and validated with an error-correcting algorithm.

The amount of data that can be stored in the QR code symbol depends on the datatype (mode, or input character set), version (1, . . . , 40, indicating the overall dimensions of the symbol, i.e. 4×version number+17 dots on each side), and error correction level. The maximum storage capacities occur for version 40 and error correction level L (low), denoted by 40-L.

4. Flagtags

In some embodiments, the sensor is, or contains, a flagtag. A flagtag is a label or tag containing a digital trigger, such as RFID, such that a portion of the tag or label can be offset from the rest of the tag or label. This can be helpful in reducing or eliminating interference between the item to which the tag or label is attached and the digital trigger (e.g., metallic item or packaging and an RFID metallic antenna. A variety of flagtag constructions are known in the art. In some embodiments, the construction has a fold to create the offset. An example is the Midas Flagtag® available from Avery Dennison. However, other flagtag constructions can be used.

5. Electronic Article Surveillance

In some embodiments, the methods described herein includes methods, systems, hardware, and sensors for electronic article surveillance (EAS) for loss prevention. Exemplary methods, systems, hardware, and sensors are described in U.S. Ser. No. 62/970,913; 62/970,933; and 62/981,206, which are incorporated herein by reference.

a. Inlays

In some embodiments, an electronic article surveillance system includes at least one RFID device having an antenna. The system further includes a first read zone and a second read zone, with a relatively small transition zone positioned there between. The conductivity of the antenna of the at least one RFID device is reduced to reduce the peak sensitivity of the at least one RFID device and to increase the bandwidth of the at least one RFID device, thereby allowing for the transition zone to be relatively small without the at least one RFID device being read in the first read zone while in the second read zone and without the at least one RFID device being read in the second read zone while in the first read zone.

In other embodiments, an EAS system includes a first RFID device having a first antenna and associated to a first article and a second RFID device having a second antenna and associated to a second article. The system also includes a first read zone and a second read zone, with a transition zone positioned there between and configured to prevent an RFID device from being read in the first read zone while in the second read zone and to prevent an RFID device from being read in the second read zone while in the first read zone. The first and second articles are configured to differently affect performance of the associated RFID device, with the first and second antennas being differently configured based at least in part on the nature of the associated articles so as to have similar read range at a predetermined frequency.

In still other embodiments, an EAS system is provided for determining a position of an RFID device configured to transmit a return signal upon receiving an RF signal. The electronic surveillance system includes first and second read zones, first and second receiving antennas, and a controller. The first receiving antenna is configured to receive a return signal at a first strength, while the second receiving antenna is configured to receive the return signal at a second strength. The controller is configured to determine whether the RFID device is positioned in the first read zone based at least in part on the difference between the first and second strengths.

In some embodiments, the EAS system determines the position of an RFID device configured to transmit return signals upon receiving RF signals. The electronic surveillance system includes first and second read zones, first and second receiving antennas, and a controller. The first receiving antenna is configured to transmit a first RF signal to the RFID device and to change the power of the first RF signal to a first power corresponding to a threshold at which a first return signal from the RFID device is received by the first receiving antenna. The second receiving antenna is configured to transmit a second RF signal to the RFID device and to change the power of the second RF signal to a second power corresponding to a threshold at which a second return signal from the RFID device is received by the second receiving antenna. The controller is configured to determine whether the RFID device is positioned in the first read zone based at least in part on the difference between the first and second strengths.

b. Readers

In some embodiments, an EAS system includes a first read zone having an associated RFID reader and a second read zone having an associated RFID reader configured to detect an RFID device at a trigger threshold. The system further includes a controller configured to set the trigger threshold based at least in part on a factor selected from the group consisting of a value of a sensor of an RFID device, a number of times that an RFID device is detected in the first read zone, and whether an RFID device is detected in the first read zone under predetermined conditions.

In other embodiments, an EAS system includes a first read zone including an associated RFID reader, with a piece of infrastructure at least partially positioned within the first read zone. An RFID guard device is secured with respect to the piece of infrastructure. A second read zone of the systems includes an associated RFID reader configured to detect an RFID inventory device associated with a piece of inventory removably associated with the piece of infrastructure at a trigger threshold. The system also includes a controller configured to, when the RFID guard device is detected by the RFID reader, initiate a response selected from the group consisting of modifying the trigger threshold, modifying an amount of power transmitted by the RFID reader associated with the second read zone, modifying a direction in which power is transmitted by the RFID reader associated with the second read zone, and transmitting a signal indicative of a need to move the piece of infrastructure away from the second read zone.

B. Hardwired RFID Read Points

In some embodiments, RFID read points are selected to work within a broader ecosystem, such as a vision- or camera-based walk out shopping system. Read points include both hardware and software. In some embodiments, data/data sets are collected in standard consumer journeys. In other embodiments, data/data sets are collected in outlying consumer journeys. In some embodiments, data is collected via local-reads and/or wide-area read points.

1. Hardware

a. Local Read Devices

In some embodiments, local-read points are or contain shelf level reading devices that monitor the presence and the timestamp of last seen data from a given space. In some embodiments, the local read points are fully functional packaged units for ease of use, aesthetics, adaptability to existing fixtures, reducing or eliminating on-premises hardware requirements, and reducing cabling. In some embodiments, the devices publish unique item ID, time stamp, location, and type of event trigger to a defined destination. In some embodiments, event based data is sent directly from the reader with no on-premises server.

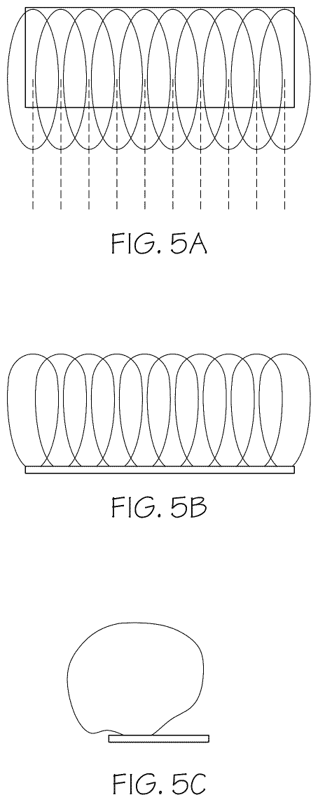

In some embodiments, the local read device is a phased array antenna grid (FIG. 5). Phased array antenna grids provide a controllable read zone segment by cycling through signals that are transverse in phase. The result is a controlled and confined read zone that can be digitally progressed across a surface. A plurality of alternating phased elements create a grid section allowing for x-axis location recognition.

In some embodiments, the local read device is a mobile device. The mobile device includes, but is not limited to, smart phones, smart watches, fitness trackers, and cameras.

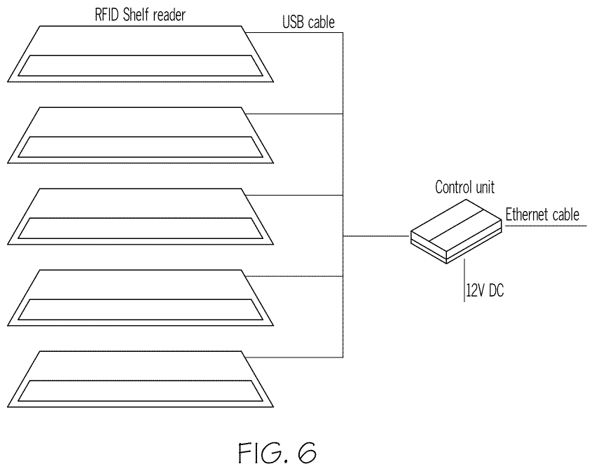

In some embodiments, the local read device is a smart shelf, such as the AD89A-FPA shelf reader from Avery Dennison. In some embodiments, the shelf reader contains a reader control board and an array of RF antennae. In some embodiments, each set of antenna creates a defined read zone and the read zones are cycled across the length of the shelf reader electronically. In some embodiments, each smart shelf is connected via USB cable to a control unit which contains a processing unit. An exemplary architecture is shown in FIG. 6. The architecture shown represents a 5 port control unit; however, larger capacity can be deployed. Additional features, such as WiFi network connectivity, can be added to the control unit. Each set of shelf readers is a self-contained network device delivering event based data to the network via the control unit.

In some embodiments, the local read device contains, or is in, a parent-child configuration. In some embodiments, the parent-child configuration contains a parent smart shelf that controls and powers one or more child smart shelves. Such a configuration may reduce cost since it contains a single parent (master) shelf rather than a plurality of parent (master) shelves with their own control and power units.

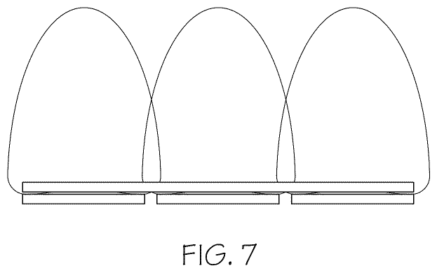

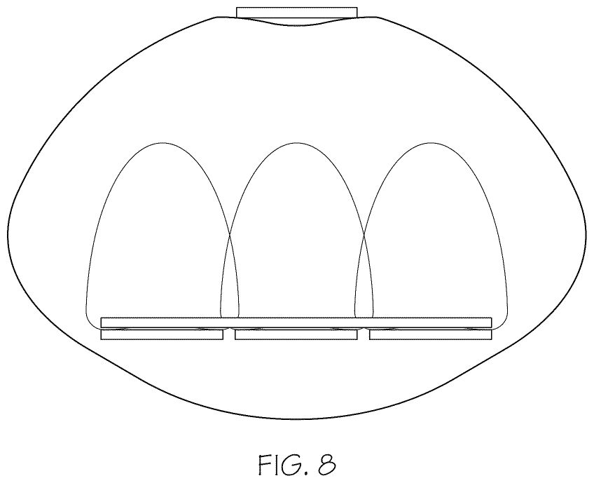

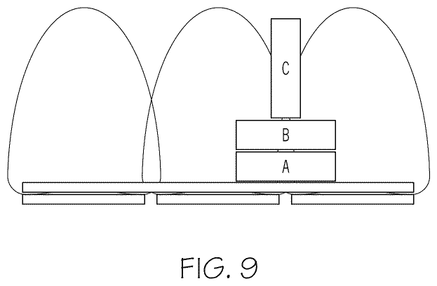

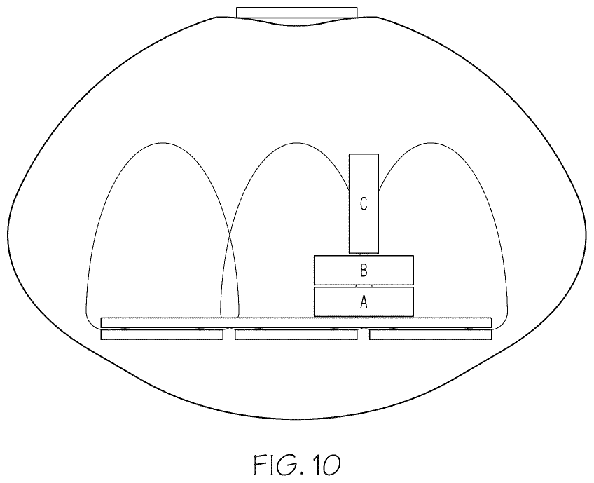

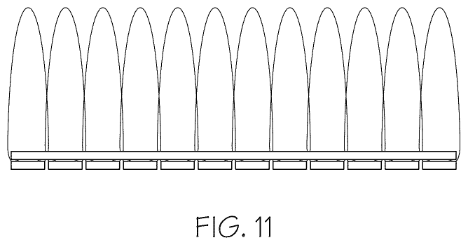

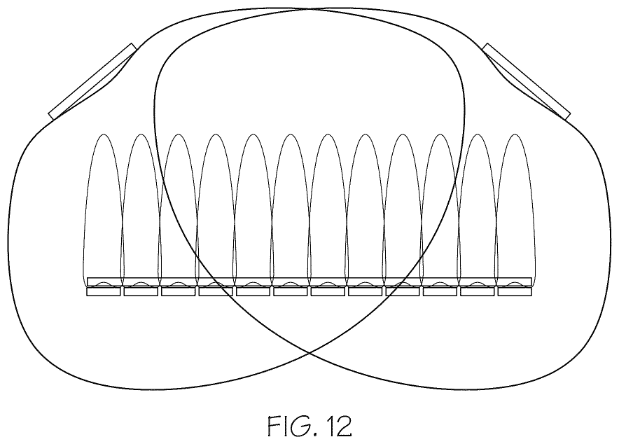

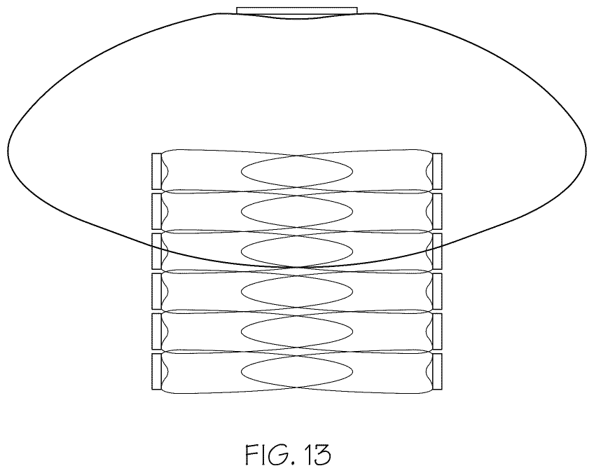

In some embodiments, the local read device is a smart shelf with an RFID read device and/or a single or plurality of RFID antenna (FIGS. 7-13). In some embodiments, the antenna are classified in two groups: short response within the direct confines of the physical shelf and long response whereas the read area extends a distance beyond the physical shelf and with its farthest read edge at a distance from the physical shelf. In some embodiments, the short response antenna are placed in close proximity to one or more products in read area #1. This read area may be made up of multiple antenna or read zones. Within read area #1 products tagged with UHF RFID (wireless detection, RF detection, etc.) are detected for the purpose of detecting an exit event or an entry event. In some embodiments, read area #1 has a closely controlled read zone so as to produce a quick response due to the short distance a picked product travels before it leaves read area #1 upon product exit or entry and having that response be in close proximity to the shelf and the standard merchandising product configuration. Exit events from read area #2 are perceived as taking longer due to the edge of read zone 2 being a distance from the physical shelf.

It is common in retail locations for products to be disrupted from their standard merchandising configuration/location by shoppers and/or other means. The result can be that product tagged with UHF RFID is stacked in a manner that does not meet standard merchandising standards thereby eluding detection from read area #1. Read area #1 is the primary data delivery zone and is therefore a highly controlled zone with more definition and operates in close proximity to products.

In some embodiments, the long response antenna produces read area #2 that is also monitoring the shelf but does so with a read field that is either higher in power or leveraging a different type of RF read field, resulting in a stronger and larger read area. Read area #2 is detecting entry events and exit event is a similar fashion to area #1 however read area #2 captures a greater space and therefore has a slower perceived reaction time. Data from Read area #2 is utilized to correct data representing products not presented to, or detected by, read area #1 based on product position or position of multiple products blocking visibility to read area #1.

In some embodiments, the relative size of the read areas is reversed, e.g., read area #1 is larger and read area #2 is smaller as described above.

For example, Products A, B, and C are located on a smart shelf. Product C is blocked from read area #1 based on the position of product C and product A+B. However, Product C is detected by read area #2 so as to notify the system that product C is still present on the shelf.

When product C is selected or picked from the shelf the data generated will include a designation that the exit occurred on read area #2 but not read area #1. This information provides depth of data to the system and notifies the system that a pick event from the shelf might have been delayed and inconsistent with a typical response time due to read area #2 covering a larger area. Detection only by read area #2 likely represents a non-standard product merchandising of product or products. Detection in read area #2, but not read area #1, can generate a notification to staff that product(s) that should be visible to read area #1 if properly merchandised is not visible and therefore requires re-merchandising by staff.

In some embodiments, the number of read zones is greater than 2 or less than 2, for example, 1, 3, 4, 5, or a greater number of read zones. In some embodiments, the multiple read areas have dual functions in both defined read areas, e.g., short range and long range. In still other embodiments, particular read areas have functions within another read area. In still other embodiments, the multiple read areas intersect and are generated from the same plane.

In some embodiments, data from distinct read areas are combined to provide depth in data or enrich data or generate more accurate data.

In some embodiments, data can be reported in an event type fashion to signify if an item is visible in only one of the read areas or in both of the read areas, timing between exits, be governed by different filters or settings or data events within multiple read areas.

In some embodiments, the data string may be represented by the following:
[Tag ID, Time stamp, Read Area #1 last seen, Read Area #2 last seen, event entry/exit, RSSI, Doppler, Read Rate, reader, antenna, antenna zone, other data points]

Data from a plurality of defined read areas may provide depth in data for machine learning, artificial intelligence, localized software and actionable data.

The hardware configurations described above may vary depending on system design, leveraging near-field, mid-field or far-field antenna designs. Combining antenna types within a read area, having only one type of antenna per read area, having different antenna types in read area #1 than read area #2 or other.

Other sensors and data inputs may also be desirable. These sensors might be non-RF based sensors such as vision, infrared, ultrasonic or other known devices.

b. Wide Area Read Devices

In some embodiments, wide-area represents or defines a read zone or multiple read zones that cover the area of the product while at rest as well as the area around where the product is merchandised. In some embodiments, wide-area coverage includes but is not limited to RFID real-times locations systems (RTLS) that report back x and y coordinates. RTLS is typically used to pinpoint the exact location of items within a facility. In some embodiments, RTLS works through a combination of Bluetooth technology and GPS in order to monitor and track objects and interactions when they occur. In some embodiments, the RTLS functionality of the RFID reader is used only to complement the existing sensor suite or the multi-detector system in use. For example, one or more detectors used in the multi-detector system described herein functions as a RTLS.

In some embodiments, the wide area read device is or contains a phased array of overhead readers that work with multiple read zones in a north, south, east, and west configuration. These multiple zones can be used to generate an x and y coordinate. In some embodiments, this RF coordinates are combined with vision coordinates for an item to help provide confirmation after product selection. In some embodiments, the wide area read device contains a read zone or multiple read zones that covers the local read area wherein the tagged variable weight-price item rests as well as the area around where the tagged variable weight-price item is merchandised in a merchandising and/or storage area.

In some embodiments, the localized area contains a shelf or a series of shelves including a smart shelf or smart shelves.

In some embodiments, the localized area contains a storage container. In some other embodiments, the localized area contains a storage area.

2. Data Paths/Software

In some embodiments, the system receives various formats of data from a plurality of different data sources, repackages the received data for a particular destination, and securely and reliably delivers the packaged digital identity data. Methods and systems for receiving and processing data are described in U.S. Ser. No. 63/034,079, which is incorporated herein by reference.

In some embodiments, the data delivered from the present invention is a set of data or a segment of data from one of a plurality of data sources. These various data sources may be a number of different sensors that collect data based on their particular purpose. The invention anticipates combining data from a single or from a plurality of read areas and combining the multiple data inputs at a repository and/or delivering singular or multiple data sets to machine learning algorithms and/or artificial intelligence systems.

In some embodiments the data delivered from the present invention is combined with other data sources to determine system actions or activity and/or initiate or negate system internal or external notifications.

In some embodiments external sensors collect data that influence the thresholds and events delivered by the present invention.

In some embodiments data and/or event data influences the thresholds and events delivered by external and/or other sensors.

In some embodiments data sources may cross communicate with each other for the purpose of dynamically adjusting settings within that source device. This method provides dynamic adjustment influenced by the environment as interpreted by other data sources or source devices and sensors.

In some embodiments, the system contains a repository for receiving data about a serialized item from a source, i.e., an item containing a unique digital identity. In some embodiments, the repository may be a designated application, such as a cloud application, for example, an intermediate software. In other embodiments, the cloud application may be a platform that assigns and/or manages unique digital identifies for tagged products. Such a platform can provide supply chain information, authentication, track and trace, brand protection, and/or customer engagement experiences. In some embodiments, the platform can receive data about the serialized item from the source and manage the product's digital identity. The repository may similarly manage a volume of inventory of the product based on the received information from the source, and is further configured to combine or aggregate the received data about the product with other product specific data, environmental specific data, consumer behavior data, or other variable and/or fixed data feeds.

In some embodiments, the serialized item may be a RFID tagged, UPC coded or ERP coded product that contains a digital identity about the product that is readable by a source. The digital identity may contain a product unique identity, an item expiration, or other product related data, and the source of the data may contain an edge device, such as smart shelves, smart coolers, smart stores, or smart storage having a RFID reader/interrogator that has an electronic display and that monitors the products in proximity thereto. For example, when the serialized item is removed from, to, or around the source, the source may communicate that information to the repository. In some embodiments, the source may be a handheld device, such as a mobile device including, but not limited to, a smart phone, tablet, smart watch, etc.

In some embodiments, the system further contains a single or plurality of digital destinations including, but not limited to, cloud application(s). The destination application is configured to receive and publish the combined data sent from the repository via a connector. The connector may be an active directory gateway, cloud connector or the like. The destination application can provide product data, availability, inventory, etc. to searchers in a local area. Additionally, pricing information related to the product may be manipulated by the destination application based on, for example, the product expiration date, shelf life or other data that suits user need and/or preference.

The destination application may then publish the data in a searchable format. Additionally, the destination application can transmit the data back to the source or other electronic display at a retail location, so that the same may benefit from the aggregated and/or updated data. For example, a consumer could view an identical price for the product online at the destination application that they would see at the retail location.

In some embodiments, the methods and systems are as described above and the systems contain a destination cloud application for receiving, manipulating, and publishing data about a serialized item from a source. The serialized item may include, without limitation, a RFID tagged, UPC coded or ERP coded product that contains a digital identity about the product that is readable by the source. The digital identity may include a product unique identity, an item expiration, or other useful product data. The source may be an edge device which can contain a fixed or handheld device for communication with sensors or machine readable code, such as smart shelves, smart coolers, smart stores, or smart storage and having a RFID reader/interrogator that has an electronic display and monitors the products/serialized items located at the source. For example, when a serialized item is removed, added, or manipulated by a customer or staff from, to, or around the source, the source may communicate that information to the destination cloud application.

Similar to the previous embodiment referenced above, the destination cloud application receives the data about the serialized item from the source, and manages the product's digital identity via a connector. The destination cloud application similarly manages a volume of inventory of the product based on the received information from the source. The destination cloud application is configured to combine the received data about the product with other product specific data. The connector may be an active directory gateway, cloud connector or similar device. The destination cloud application can then provide the combined product data or any portion thereof to searchers in a local area. Additionally, pricing information related to the product may be manipulated by the destination cloud application based on, for example, the product expiration date, shelf life or other useful data.

The destination cloud application may then publish the data in a searchable format available to consumers in a local area. Additionally, the destination application or repository can transmit the data back to the source or other electronic display at a retail location, which may also use the combined data. For example, a consumer may view an identical price for the product online at the destination cloud application that they would see at the retail location.

In other embodiments, the methods and systems described herein include processes for increasing migration and accessibility of product related data. The system contains a designated application, such as a cloud application, for receiving data about a serialized item from a source, and the designated application may be an intermediate software. As above, the serialized item may be an RFID tagged, UPC coded or ERP coded product that contains a digital identity about the product that is readable by the source, and the digital identity may contain a product unique identity, an item expiration, or other useful product data or information. The source may be an edge device, such as smart shelves, smart coolers, smart stores, or smart storage with a RFID reader/interrogator that has an electronic display and the ability to monitor the serialized items. For example, when a serialized item is removed from the source, the source may communicate that information to the repository which may, in turn, update the product data stored therein.

The designated application is configured to receive the data about the serialized item from the source, and manage the product's digital identity. The designated application similarly manages a volume of inventory of the product based upon the received information from the source. The designated application is further configured to merge the received data about the product with other product specific data, and may also receive data related to the serialized item from a plurality of data collection points. The plurality of data collection points are sources that do not otherwise lend themselves to a data share atmosphere, such as inventory scans, point of sale data, distributor data, data center data or the like.

The system can further contain a destination application. The destination application is configured to receive, manipulate, and publish the combined data sent from the designated cloud application. The destination application can provide product data, availability, and inventory data to searchers in a local area. Additionally, pricing information related to the product may be manipulated by the destination application based upon the product expiration, shelf life or other data related to the product.

The destination application, e.g., cloud application, then publishes the combined data in a searchable format for consumers in a local area. Additionally, the destination application can transmit the data back to the source or other electronic display at a retail location. A consumer could then view an identical price for the product online at the destination application that they would see at the retail location, and determine if there is local inventory in stock for purchase.

In some embodiments, the methods described herein include or contain edgeware. Edgeware is embedded software that operates in the reader hardware, eliminating the need for on-premises computer equipment and servers. Edgeware simplifies the data path and reduces the software development demands on users. In some embodiments, edgeware delivers event based data, as described above, directly from the reader to local and/or cloud destinations. The event based data is reliable and the software is optimized to reduce stray reads and provide the flexibility to adjust the volume of data delivered from the device to the data destination.

In some embodiments, various data strings for event based data can be defined and delivered. For example:
AAAABBBBCCCCDDDDEEEE0002, (reader name), 7, InField, 2019-12-03T19:16:41.552010Z (EPC, reader name, antenna #, event type, time stamp)
AAAABBBBCCCCDDDDEEEE0003, Z1, FSeen, 2019-02-06T18:59:06z, LSeen, 2019-02-06T18:59:06z (EPC, Zone identifier, first seen, time stamp, last seen, time stamp)

3. In-Store Tagging Methods and Commissioning of Unique Digital IDs

In some embodiments, the method includes the assignment of unique ID and commissioning. In some embodiments, the assignment and commissioning are done at a service bureau. In other embodiments, assignment and commissioning is performed on location at the retail brand owner or retailer. In some embodiments, a portable print/write device can be used. For example, Pathfinder™, available from Avery Dennison, writes EPC data and prints human readable data on an adhesive backed RFID tag. In some embodiments, the portable device is the Pathfinder 6059 model handheld device. This device has a built in RFID encoder which allows for the unique ability to scan barcodes, encode RFID, print labels, and apply labels to packaged food products, in one streamlined process. The average process time to accomplish this action sequence is approximately 4 seconds, enabling high throughput tagging which is ideal for in-store applications such as reading the tagged variable weight-price items or perishable items. The method described herein is also useful for detecting transitions at merchandising and/or storage locations or areas, i.e. movement of the items from one side to the other such as movement from room to room or from the shelves to off the shelves. The movement of the items typically occurs during verification of the items or during replenishment of the items during merchandising etc. Detections can also be done at points of sale, alone or in combination with detection at merchandising and/or storage locations or areas.

C. Identifying Images in Close Proximity to a Mobile Device and/or within a Digital Image

In some embodiments, the system described herein include methods for identifying items that are in close proximity to a mobile device and/or are within a digital image. Methods for such identification are described in U.S. Ser. No. 63/026,392, which is incorporated herein by reference.

The mobile device includes, but is not limited to, smart phones, smartwatches, fitness trackers, and cameras. In some embodiments, the location of the mobile device is determined using one or more methods or techniques known in the art. Suitable methods and techniques include, but are not limited to, outdoor positioning systems (“OPS”) and indoor positioning systems (“IPS”). Exemplary OPS include, but are not limited to, the global positioning system (“GPS”).

Exemplary IPS include, but are not limited to, non-radio technologies and wireless technologies. Examples of non-radio technologies include, but are not limited to, magnetic positioning, inertial measurements, positioning based on visual markers, and location based on known visual features. Examples of wireless technologies include, but are not limited to, ultra wide band (UWB), WiFi positioning system (WiPS or WFPS), Bluetooth, Bluetooth 5.1, Bluetooth low energy (BLE), choke point concepts, grid concepts, long range sense concepts, angle of arrival, time of arrival, received signal strength indication, and combinations thereof.

In some embodiments, the method or techniques used to determine the location of the mobile device is accurate within 5 meters, 4 meters, 3 meters, 2 meters, 1 meter, 0.9 meters, 0.8 meters, 0.7 meters, 0.6 meters, 0.5 meters, 0.4 meters, 0.3 meters, 0.2 meters, or 0.1 meters.

In some embodiments, the location of the mobile device is determined using one or more techniques described herein and one or more items in close proximity to the mobile device are identified. In some embodiments, the term “close proximity” means within about 10 meters, 9 meters, 8 meters, 7 meters, 6 meters, 5 meters, 4 meters, 3 meters, 2 meters, 1 meter, 0.9 meters, 0.8 meters, 0.7 meters, 0.6 meters, 0.5 meters, 0.4 meters, 0.3 meters, 0.2 meters, or 0.1 meter. However, the item or items may be further away.

The identity of the item or items can be determined using one or more techniques known in the art. Exemplary techniques include, but are not limited to, planograms; visual inventory; RFID handheld inventory; RFID overhead inventory; vision system inventory; QR; barcode; NFC; or other methods known in the art.

In some embodiments, one or more items at the location of the mobile device have attached thereto one or more sensors which can be detected by localized scanners. Such items are said to be digitally identified. The sensors can be incorporated into a label, such as a pressure adhesive label or other type of label, or a tag, such as a hanging tag. The sensor can be any sensor known in the art that is suitable for the methods and applications described herein. In some embodiments, the sensor is, for example, a radio frequency identification (RFID, such as UHF or HF) sensor, a near field communication (NFC) sensor, a quick response (QR) code, machine readable code, vision system, Bluetooth Low Energy (BLE) beacons, or other digital identification (ID) systems. In some embodiments, the location of the mobile device is determined by one or more of the techniques described above and the items in proximity to the mobile device are identified using UHF RFID. In some embodiments, the digital ID system is UHF Gen2 RFID or similar standard.

In some embodiments, the methods described herein include or involve identifying one or more items within a digital image, such as a photograph or video. The photograph or video can be taken using a mobile device including, but not limited to, smart phone, tablet, smartwatch, digital camera, etc. In some embodiments, the one or more items within the photograph or video have a digital ID recorded by a reader in the device itself, a smart shelf, a scheduled inventory run, or other digital ID reader. In some embodiments, the image has an identification (ID)/time stamp that is used to associate the items in the image that have been read in the same area as the image so that the items can be actively searched as a digital image to highlight or list items that are in the image. In some embodiments, the identification (ID) stamp that indicates the location of the device used to take the photograph or video can be determined or generated using one or more of the techniques described above.

In some embodiments, the location of the device and the item or items in proximity and/or located within a photograph or video are stored in a digital repository. In some embodiment, the location of the device and the item or items are stored in the same digital repository or different digital repositories. The digital repository can be a cloud based application, locally hosted (e.g., on the device itself or a device on the premises, such as a lap top, tablet, or mobile device), or combinations thereof. In some embodiments, the location of the device and the identity of the item or items are stored in a digital repository as described above and the location of the device and the identity of the item or items are associated with each other such that the items and information thereon are provided to a user, e.g., a customer. The user can manually search/navigate all identified items. Alternatively, the user can search manually in combination with one or more filters to limit or reduce the number of items presented to the user. For example, the user may wish to look only at a certain type of garment or clothing, such as shirts, pants, sweaters, jackets, etc.; footwear, accessories, such as jewelry, etc. In other embodiments, the filter(s) may limit the items presented to the user by garment type as well as color and/or size; availability; etc. When the user sees one or more items of interest, they can select the items to see additional information. The methods described herein can also include a search feature to control the viewability, experience, and/or order in which items are displayed. For example, the user can slide content away or slide content to save. In alternative embodiments, the user could check a box or indicate interest using other known methods.

Examples of the type of the information provided to the user include, but are not limited to, location, price, size, availability, coupons or discounts, related or complementary information about the item, such as sustainable materials and manufacturing, interactive consumer experiences, and combinations thereof.

1. A method for detecting one or more variable weight-price items or perishable items in vision- or camera-based checkout systems, the method comprising affixing to the variable weight-price items one or more tags comprising an inlay comprising one or more unique digital identities and one or more digital triggers and detecting activity of the tagged variable weight-price items or perishable items, via the digital triggers in a localized area.

2. The method of claim 1, wherein the one or more digital triggers is selected from the group consisting of HF RFID, UHF RFID, NFC, QR codes, and combinations thereof.

3. The method of claim 1, wherein the inlay is suitable for application to plastic packaging.

4. The method of claim 1, wherein the inlay is a low profile inlay.

5. The method of claim 1, wherein the inlay is a microwave-safe inlay.

6. The method of claim 1, wherein the tagged variable weight-price items are detected by a local area read device, a wide area read device, or combinations thereof.

7. The method of claim 1, wherein the local area read device is a smart shelf.

8. The method of claim 1, wherein the local area read device is a mobile device.

9. The method of claim 7, wherein the smart shelf comprises a phased array antenna.

10. The method of claim 7, wherein the smart shelf comprises a parent-child shelf configuration.

11. The method of claim 7, wherein the local area read device comprises a plurality of antenna that are classified as short response and long response, wherein the short response antenna is in close proximity to the one or more products to be detected and the long response antenna are in a proximity close to, but further away than the short response antenna, and comprises a read field that is either higher in power than the short response antenna or uses a different type of RF read field.

12. The method of claim 1, a wherein the wide area read device comprises a read zone or multiple read zones that covers the local read area wherein the tagged variable weight-price item rests as well as the area around where the tagged variable weight-price item is merchandised.

13. The method of claim 12, wherein the wide area read device comprises a phased array of overhead readers that work with multiple read zones in a north, south, east, and west configuration.

14. The method of claim 1, wherein the tagged variable weight-price items or perishable items can be read using a handheld reader.

15. The method of claim 1, wherein the local area read device, the wide area read device, the handheld reader, or combinations thereof contain edgeware which sends data directly from the read device or reader to one or more local and/or cloud destinations.

16. The method of claim 1, wherein the digital trigger further comprises electronic article surveillance (EAS) functionality.

17. The method of claim 1, wherein the localized area is an area in a retail location.

18. The method of claim 1, wherein the retail location is a grocery store.

19. The method of claim 1, wherein the variable-weight items are selected from the group consisting of cheeses, meats, seafood, fruits, vegetables, and combinations thereof.

20. The method of claim 1, wherein the activity comprises inventory management or merchandising of the one or more weight-price or perishable items.

21. The method of claim 20, wherein the inventory management comprises confirming the presence or absence of the one or more items.

22. The method of claim 1, wherein the activity comprises adding or removing an item from the localized area.

23. A method for detecting the activity of one or more variable weight-price or perishable items using a multi-detector system, the method comprising affixing to the variable weight-price items one or more tags comprising an inlay comprising one or more digital identities and one or more digital triggers and detecting the tagged variable weight-price item activity, via the digital trigger, in a merchandising and/or storage area.

24. The method of claim 23, wherein the multi-detector system comprises one or more detectors comprising a camera or other vision-based devices.

25. The method of claim 23, wherein the activity comprises inventory management or merchandising of the one or more variable weight-price items or perishable items.

26. The method of claim 25, wherein inventory management involves confirming the presence or absence of the one or more items.

27. The method of claim 23, wherein the activity comprises adding or removing at least one of the one or more variable weight-price items from the localized area.

28. The method of claim 23, wherein the localized area comprises a shelf.

29. The method of claim 28, wherein the localized area comprises a series of shelves.

30. The method of claim 28, wherein the shelf or shelves comprises a smart shelf or smart shelves.

31. The method of claim 27, wherein the localized area comprises a storage container for the variable weight-price items or perishable items.

32. The method of claim 27, wherein the localized area comprises a storage area.

33. The method of claim 24, wherein the one or more detectors in the multi-detector system comprises a mobile phone.

34. The method of claim 24, wherein the one or more detectors in the multi-detector system functions as a real time location system.

35. The method of claim 23, wherein the one or more digital identities is configured as a machine readable code.

36. The method of claim 23, wherein the one or more digital identities is associated with metadata.

37. The method of claim 23, wherein the one or more digital identities is associated with an image.

38. The method of claim 23, wherein the inlay is a Bluetooth Low Energy (BLE) tag.

39. The method of claim 23, wherein the one or more digital triggers comprises electronic article surveillance (EAS) functionality.

40. The method of claim 2, wherein the inlay is suitable for application to plastic packaging.

41. The method of claim 29, wherein the shelf or shelves comprises a smart shelf or smart shelves.
